(19) United States
(12) Patent Application Publication
(10) Pub. No.: US 2026/0064393 A1
(43) Pub. Date: Mar. 5, 2026

(54) METHOD AND APPARATUS FOR PROCESSING CODE, AND METHOD AND APPARATUS FOR TRAINING CODE MODEL, AND DEVICE

(71) Applicant: Beijing Baidu Netcom Science Technology Co., Ltd., Beijing (CN)

(72) Inventors: Wanpeng NIU, Beijing (CN); Hui LI, Beijing (CN); Yunpeng PENG, Beijing (CN); Junwei XING, Beijing (CN); Bingfei ZHANG, Beijing (CN); Xiangfei MIN, Beijing (CN); Ze CHEN, Beijing (CN)

(21) Appl. No.: 18/989,191

(22) Filed: Dec. 20, 2024

(30) Foreign Application Priority Data
Sep. 5, 2024 (CN) 202411246680.5

(51) Int. Cl. G06F 8/41

(52) U.S. Cl. CPC G06F 8/443; G06F 8/433

(57) ABSTRACT

The present disclosure provides a method and apparatus for processing code, a method and apparatus for training a code model, and a device, which relates to the field of artificial intelligence, and in particular, to the technical fields of software development, data processing, large models and computer communication. The method for processing code includes: acquiring target pasted code in response to a code paste event being monitored; performing dependency analysis for the target pasted code to obtain context-dependent data corresponding to the target pasted code; performing, according to the context-dependent data, code optimization for the target pasted code to obtain optimized code corresponding to the target pasted code; and outputting the optimized code. The present disclosure can greatly improve development efficiency, seamlessly integrate optimized code into the current code development environment, and improve code quality.

### CROSS-REFERENCE TO RELATED APPLICATION

This application claims priority to Chinese Patent Application No. 202411246680.5, filed on Sep. 5, 2024, which is hereby incorporated by reference in its entirety.

### TECHNICAL FIELD

The present disclosure relates to the technical fields of software development, data processing, large models and computer communication in the field of artificial intelligence, and in particular, to a method and apparatus for processing code, a method and apparatus for training a code model, and a device.

### BACKGROUND

In software development environments, a developer often make frequent use of copy and paste functions for code to improve coding efficiency.

Currently, a developer can paste code from other places (such as code previously written by the developer or code in other files, etc.) into an integrated development environment (IDE). However, pasted code often can not be directly applied to the current code development environment, the developer needs to interrupt a coding process and modify the pasted code, resulting in greatly reduced development efficiency. Therefore, there is an urgent need for an effective scheme to optimize pasted code.

### SUMMARY

The present disclosure provides a method and apparatus for processing code, a method and apparatus for training a code model, and a device for optimizing pasted code.

According to a first aspect of the present disclosure, a method for processing code is provided, including:
acquiring target pasted code in response to a code paste event being monitored;
performing dependency analysis for the target pasted code to obtain context-dependent data corresponding to the target pasted code;
performing, according to the context-dependent data, code optimization for the target pasted code to obtain optimized code corresponding to the target pasted code; and
outputting the optimized code.

According to a second aspect of the present disclosure, a method for training a code model is provided, including:
acquiring a training data set, where training data in the training data set includes a pasted code sample, a context-dependent data sample of the pasted code sample and label code, the label code is code collected within a coordinate range of the pasted code sample in a case that the pasted code sample is pasted into a code development environment and passes a preset waiting time; and
iteratively training, based on the training data set, a code optimization model until a calculated loss function value meets a preset evaluation condition or a number of iterations reaches a preset number of iterations, to obtain a trained code optimization model.

According to a third aspect of the present disclosure, an apparatus for processing code is provided, including:
an acquisition unit, configured to acquire target pasted code in response to a code paste event being monitored;
a dependency analysis unit, configured to perform dependency analysis for the target pasted code to obtain context-dependent data corresponding to the target pasted code;
a code optimization unit, configured to perform, according to the context-dependent data, code optimization for the target pasted code to obtain optimized code corresponding to the target pasted code; and
an output unit, configured to output the optimized code.

According to a fourth aspect of the present disclosure, an apparatus for training a code model is provided, including:
an acquisition unit, configured to acquire a training data set, where training data in the training data set includes a pasted code sample, a context-dependent data sample of the pasted code sample and label code, the label code is code collected within a coordinate range of the pasted code sample in a case that the pasted code sample is pasted into a code development environment and passes a preset waiting time; and
a training unit, configured to iteratively train, based on the training data set, a code optimization model until a calculated loss function value meets a preset evaluation condition or a number of iterations reaches a preset number of iterations, to obtain a trained code optimization model.

According to a fifth aspect of the present disclosure, an electronic device is provided that includes: at least one processor; and a memory communicating with the at least one processor; where the memory stores instructions that can be executed by the at least one processor, and the instructions are executed by the at least one processor to enable the at least one processor to execute the method for processing code described in the first aspect or the method for training the code model described in the second aspect.

According to a sixth aspect of the present disclosure, a non-transitory computer-readable storage medium storing computer instructions is provided, where the computer instructions are used to cause a computer to execute the method for processing code described in the first aspect or the method for training the code model described in the second aspect.

According to a seventh aspect of the present disclosure, a computer program product is provided, the computer program product includes: a computer program, the computer program is stored in a readable storage medium, at least one processor of an electronic device can read the computer program from the readable storage medium, and the at least one processor execute the computer program to cause the electronic device to execute the method for processing code described in the first aspect or the method for training the code model described in the second aspect.

The technology of the present disclosure solves the problem that pasted code often cannot be directly applied to the current code development environment, and a developer needs to interrupt the coding process and modify the pasted code, resulting in greatly reduced development efficiency. Target pasted code is acquired in response to a code paste event being monitored; dependency analysis is performed for the target pasted code to obtain context-dependent data corresponding to the target pasted code; code optimization is performed for the target pasted code according to the context-dependent data to obtain optimized code corresponding to the target pasted code; and the optimized code is outputted. Through performing dependency analysis for the target pasted code, the overall code structure and logic can be deeply understood, the code format, quality, context understanding, semantic adaptation, etc., can be comprehensively considered, code optimization can be performed for the target pasted code automatically, which can greatly improve the development efficiency, ensure that the optimized code is consistent with the existing code in the current code development environment in style and logic, and can integrate the optimized code into the current code development environment seamlessly, improve code quality, and enhance the coding experience of the developer.

It should be understood that the content described in this part is not intended to identify critical or significant features of embodiments of the present disclosure, nor is it intended to limit the scope of the present disclosure. Other features of the disclosure will be made easier to understand by the following specification.

### BRIEF DESCRIPTION OF DRAWINGS

The drawings are used for a better understanding of the scheme and do not qualify the disclosure.

FIG. 1 is a schematic diagram of an application scenario in which a method for processing code of the present disclosure applies.

FIG. 2 is a schematic diagram according to a first embodiment of the present disclosure.

FIG. 3 is a schematic diagram according to a second embodiment of the present disclosure.

FIG. 4 is a schematic diagram according to a third embodiment of the present disclosure.

FIG. 5 is a schematic diagram according to a fourth embodiment according to the present disclosure.

FIG. 6 is a schematic diagram according to a fifth embodiment of the present disclosure.

FIG. 7 is a schematic diagram according to a sixth embodiment of the present disclosure.

FIG. 8 is a schematic diagram according to a seventh embodiment of the present disclosure.

FIG. 9 is a schematic block diagram of a example electronic device 900 that may be used to implement an embodiment of the present disclosure.

### DESCRIPTION OF EMBODIMENTS

The illustrative embodiments of the present disclosure are illustrated below in conjunction with the drawings, which include various details of the embodiments of the present disclosure to facilitate understanding and should be considered to be only illustrative. Therefore, persons of ordinary skill in the art should be aware that various changes and modifications may be made to the embodiments described herein without departing from the scope and spirit of the present disclosure. For clarity and conciseness, descriptions of known functions and structures are omitted from the following descriptions.

The present disclosure provides a method and apparatus for processing code, a method and apparatus for training a code model, and a device, which can be applied to the technical fields of software development, data processing, large models, computer communication, etc., in the field of artificial intelligence, so as to achieve the purpose of quickly correcting pasted code and ensuring that pasted code can be seamlessly integrated into the existing code environment.

In technical schemes of the present disclosure, the processing, such as collection, storage, use, processing, transmission, provision and disclosure, of the user's personal information complies with relevant laws and regulations, and does not violate public order and good customs.

First of all, some technical terms involved in the present disclosure are explained:
high quality code refers to software code that performs well in many aspects and usually has the following characteristics: (1) strong readability: clear code structure, easy-to-understand logic, canonical naming, meaningful variable and function names, with appropriate comments and documentation; (2) good maintainability: modular design, single function, low coupling and high cohesion, following design patterns and best practices; (3) high testability: high unit test coverage, ease of writing automated tests; (4) performance optimization: reasonable selection of algorithms and data structures, efficient use of resources; (5) safe and reliable: considering various abnormal situations, having an appropriate error handling mechanism, paying attention to data security and privacy protection; (6) good scalability: reasonable architecture design which is easy to expand in the future, high code reusability; (7) following coding conventions: complying with the industry's code style guidelines and maintaining consistency.

In software development environments, a developer often makes frequent use of copy and paste functions for code to improve coding efficiency. Currently, a developer can paste code from other places (such as code previously written by the developer or code in other files, etc.) into an integrated development environment. In particular, with the support of large language model (LLM) technology, the developer increasingly tends to generate code by talking to artificial intelligence (AI) programming assistants, and then paste generated code into the integrated development environment (IDE). Although the above method of pasting code speeds up the initial coding, in many cases, pasted code will be modified immediately after being pasted, the modification may range from small adjustments (such as formatting, variable renaming, symbol completion, etc.) or large-scale changes (such as business logic rewriting, etc.). This shows that pasted code often can not be directly applied to the current code development environment, can not fully conform to the business logic of the entire code file, the developer needs to interrupt the coding process to modify the pasted code, resulting in greatly reduced development efficiency. Therefore, there is an urgent need for an effective scheme to optimize paste code.

In addition, in the field of software development, improving the efficiency of code reuse and reducing duplication of work have been the focus of attention. With the development of artificial intelligence and large language model technologies, the methods of code generation and optimization are constantly evolving. In the related art, rule-based code formatting, static code analysis and intelligent code completion can be carried out on code. The rule-based code formatting is a widely used technique to uniform the appearance and structure of code. It uses a predefined set of rules to adjust formatting elements of code, such as indentation, whitespaces, or line breaks. Common tools include, e.g., code formatting tools, including Prettier, Black, gofmt, etc. These tools can automatically adjust code format to make the code conform to specific style guidelines. The static code analysis is a technique that analyzes source code without executing the program. It scans the code to detect potential error, security bugs, performance issues, and style violations. Common tools include, e.g., static code analysis tools, including SonarQube, ESLint, FindBugs, etc., which can be integrated into development environments and provide real-time feedback during the coding process. The intelligent code completion is a predictive technique for providing possible code fragment suggestions according to the current coding context, which utilizes deep learning algorithms to analyze a large code base and learn common coding modes and best practices. Typical implementations include, e.g., programming aids based on artificial intelligence, such as GitHub Copilot, Baidu Comate, which can provide context-sensitive code suggestions and significantly improve coding speed.

Although the above related art has improved the efficiency of code development and optimization in different aspects, they all have some common limitations. Specifically, the rule-based code formatting tools lack an understanding of code logic, focus only on a surface structure of the code, and fail to understand or optimize logical content of the code. The static code analysis tools, which focus on problem detection rather than active optimization, may generate a large number of false positives or missed positives, requiring the developer to invest time in manual review. The intelligent code completion tools, while powerful, mainly focus on generating code from scratch rather than optimizing existing code fragments. Most of the above related art focus on local features of the code or generate new code, lacking a deep understanding of the overall code structure and logic. They are usually passive or reactive, and unable to actively adapt to complex project requirements or specific programming context. Especially when dealing with large pieces of pasted code, the above related art is often difficult to effectively integrate new code with the existing code base seamlessly. Most importantly, the above related art lacks a comprehensive scheme to handle problems of multiple aspects, such as code format, quality, context understanding, and semantic adaptation at the same time, and in the actual software development process, the developer often needs to switch between different tools, which not only reduces work efficiency, but also can lead to inconsistent code quality. Therefore, there is an urgent need for an effective scheme that can comprehensively consider code format, quality, context understanding and semantic adaptation to optimize pasted code, so as to make up for the shortcomings of existing technologies.

In order to solve the above problems, the present disclosure provides a method for processing code. At a business level, a developer's code paste event is monitored in real-time, the corresponding target pasted code of the code paste event is acquired, and dependency analysis is performed for the target pasted code, that is, a dependency relationship and overall structure of the target pasted code in the current code file is analyzed. According to context-dependent data corresponding to the target pasted code, optimized code corresponding to the target pasted code is automatically generated, which can help the developer quickly correct the content of the pasted code, ensure that the pasted code can be seamlessly integrated into the existing code environment, and improve development efficiency and development quality.

In addition, at a model level, a code optimization model is fine-tuned based on a large amount of real developer programming data to improve the ability to understand context of the pasted code, and the output quality, of the code optimization model.

It can be seen that the method for processing code provided by the present disclosure will bring significant value to the field of software development, can effectively improve development efficiency, and greatly improve coding speed by reducing time investment of the developer in modifying code after pasting. At the same time, the present disclosure can enhance code quality, ensure that pasted code is consistent with the existing code base (Base), and reduce potential bugs (bugs) caused by code mismatches. This not only applies to various programming languages and development environments, but also provides a smarter, smoother coding experience for development teams. Especially in AI-assisted programming, the present disclosure can be seamlessly integrated with code-generation AI to provide more intelligent coding assistance, and further promote the improvement of software development efficiency and quality.

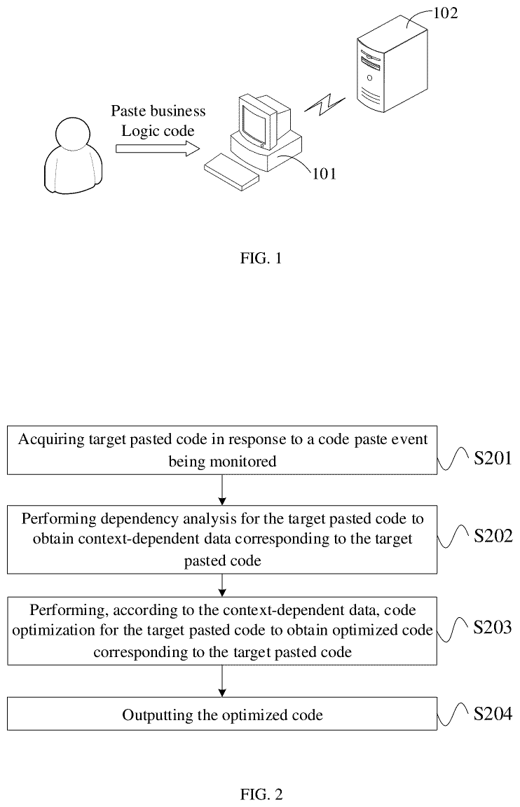

FIG. 1 is a schematic diagram of an application scenario in which a method for processing code of the present disclosure applies. In this scenario, during software development, a developer, for example, generates a piece of business logic code through a large language model, and copies and pastes the business logic code into an integrated development environment through a client 101. According to the method for processing code provided by the present disclosure, optimized code corresponding to the business logic code can be outputted through a server 102, and the optimized code can be displayed to the developer through the client 101, so that the developer can determine whether to adopt the optimized code.

It should be noted that FIG. 1 is only a schematic diagram of an application scenario provided by an embodiment of the present disclosure, and the embodiment of the present disclosure does not impose a limitation on devices included in FIG. 1, nor does it impose a limitation on a position relationship between the devices in FIG. 1.

The following uses specific embodiments to explain in detail a technical scheme of the present disclosure and how the technical scheme of the present disclosure solves the above technical problems. The following specific embodiments may be combined with each other, and the same or similar concepts or processes may not be repeated in some embodiments. Embodiments of the present disclosure are described below in conjunction with the accompanying drawings.

FIG. 2 is a schematic diagram according to a first embodiment of the present disclosure. As shown in FIG. 2, a method for processing code provided by the first embodiment of the present disclosure may be applied to an electronic device, which may be a server or a cluster of servers, etc. The method for processing code provided by the first embodiment of the present disclosure includes:

S201, acquiring target pasted code in response to a code paste event being monitored.

In the embodiment of the present disclosure, the pasted code may be code previously written by a developer, code in other files, or code generated by a large language model, etc. The embodiment of the present disclosure does not impose a limitation on the source of the pasted code. In a process of software development, for example, the developer pastes part of the code in another file into the integrated development environment. Accordingly, the electronic device executing the embodiment of this method can monitor the code paste event and then acquire the target pasted code corresponding to the code paste event. The target pasted code may be, e.g., one or more lines of code, and the target pasted code can also be understood as an original code block to paste.

S202, performing dependency analysis for the target pasted code to obtain context-dependent data corresponding to the target pasted code.

In this step, after acquiring the target pasted code, dependency analysis can be performed for the target pasted code. For example, data, such as which files, classes or functions (such as function signatures and function return values) which the target pasted code depends on, can be acquired as key data for analyzing context. Thus, the context-dependent data corresponding to the target pasted code can be obtained.

S203, performing, according to the context-dependent data, code optimization for the target pasted code to obtain optimized code corresponding to the target pasted code.

In this step, after obtaining the context-dependent data corresponding to the target pasted code, code optimization can be performed for the target pasted code according to the context-dependent data to obtain the optimized code corresponding to the target pasted code. It can be understood that according to the context-dependent data corresponding to the target pasted code, the code optimization is performed for the target pasted code, which can deeply understand the overall code structure and logic, and comprehensively consider the code format, quality, context understanding, semantic adaptation, etc., ensure that the optimized code corresponding to the target pasted code is consistent with the existing code in the current code development environment in terms of style and logic, and integrate the optimized code seamlessly into the current code development environment.

S204, outputting the optimized code.

In this step, after the optimized code corresponding to the target pasted code is obtained, the optimized code can be output. By example, difference code between the optimized code and the target pasted code can be highlighted, which helps to improve the convenience of the developer's operation, so that the developer can more quickly decide whether to adopt the optimized code.

In the embodiments of the present disclosure, target pasted code is acquired in response to a code paste event being monitored; dependency analysis is performed for the target pasted code to obtain context-dependent data corresponding to the target pasted code; according to the context-dependent data, code optimization is performed for the target pasted code to obtain optimized code corresponding to the target pasted code; and the optimized code is outputted. Through performing dependency analysis for the target pasted code, the overall code structure and logic can be deeply understood, the code format, quality, context understanding, semantic adaptation, etc. can be comprehensively considered, and code optimization can be performed for the target pasted code automatically, which can greatly improve the development efficiency, ensure that the optimized code is consistent with the existing code in the current code development environment in style and logic, integrate the optimized code into the current code development environment seamlessly, improve code quality, and enhance the coding experience of the developer.

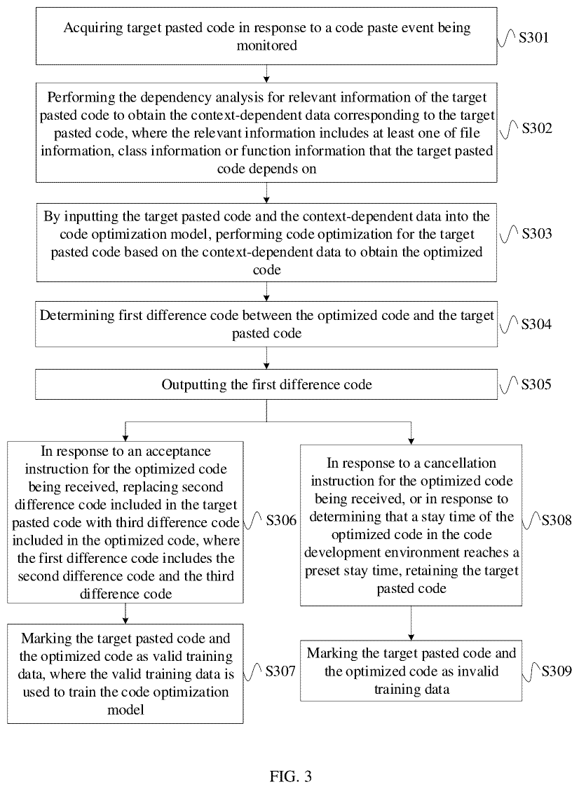

FIG. 3 is a schematic diagram according to a second embodiment of the present disclosure. On the basis of the above embodiment, the method for processing code is further explained in the embodiment of the present disclosure. As shown in FIG. 3, a method for processing code provided by the second embodiment of the present disclosure may include:

S301, acquiring target pasted code in response to a code paste event being monitored.

For the implementation principle and technical effect of S301, reference can be made to the implementation of the step S201 in FIG. 2 above, which will not be detailed here.

In the embodiment of the present disclosure, the step S202 in FIG. 2 may further include the following step S302:

S302, performing the dependency analysis for relevant information of the target pasted code to obtain the context-dependent data corresponding to the target pasted code, where the relevant information includes at least one of file information, class information or function information, on which the target pasted code depends.

By example, the dependency analysis can be performed for file information, class information or function information that the target pasted code depends on. For example, data such as which files, classes or functions (such as function signatures and function return values) that the target pasted code depends on can be acquired as key data for analyzing context. Thus, the context-dependent data corresponding to the target pasted code can be obtained.

In the embodiment of the present disclosure, the step S203 in FIG. 2 may further include the following step S303:

S303, by inputting the target pasted code and the context-dependent data into the code optimization model, performing code optimization for the target pasted code based on the context-dependent data to obtain the optimized code.

The code optimization model is acquired based on training with pasted code samples in a code development environment, context-dependent data samples of the pasted code samples and label code. The label code is code collected within a coordinate range of the pasted code sample in a case that the pasted code sample is pasted into the code development environment and passes a preset waiting time.

In this step, the code optimization model, for example, is acquired by fine-tuning training based on a common large code model, where a training data set used to train the code optimization model is acquired based on data truly annotated by a developer in the code development environment, which can ensure the authenticity, diversity and high quality of the training data set from the data origin, highly conform to the developer's programming habits, and then can ultimately guarantee the high-quality output of the code optimization model. For details on how to train to obtain the code optimization model, refer to subsequent embodiments.

By example, after obtaining the context-dependent data corresponding to the target pasted code, the target pasted code and the context-dependent data can be assembled as prompt (prompt), and the prompt can be input into the code optimization model. Accordingly, the code optimization model performs code optimization for the target pasted code based on the context-dependent data to obtain the optimized code. It can be understood that when the code optimization model performs the code optimization for the target pasted code based on the context-dependent data, it will judge whether the target pasted code needs to be optimized. For example, if the optimized code corresponding to the target pasted code acquired by the code optimization model based on the context-dependent data does not exactly match the target pasted code, the target pasted code is determined to be optimized; if the optimized code corresponding to the target pasted code acquired by the code optimization model based on the context-dependent data matches the target pasted code exactly, the target pasted code is determined not to be optimized.

In an implementation, the output of the code optimization model is empty in a case that the target pasted code is determined not to be optimized.

In this embodiment, in a case that the target pasted code is determined not to be optimized, the code optimization model may not output any information to ensure that the developer has no perception, and do not affect the developer's development efficiency.

In an implementation, code optimization performed by the code optimization model includes at least one of the following: comment addition, comment modification, variable modification, function name modification, code format adjustment, configuration parameter adjustment, code symbol completion, or business logic change.

It can be understood that when the code optimization is performed through the code optimization model, the code format, quality, context understanding, semantic adaptation, etc. are comprehensively considered. Code optimization categories can be divided into various categories such as comment addition, comment modification, variable modification, function name modification, code format adjustment, configuration parameter adjustment, code symbol completion, business logic change, etc. For example, specific code optimization categories may include more than 20 categories to ensure that the optimized code is consistent with the existing code in the current code development environment in style and logic, and the optimized code is seamlessly integrated into the current code development environment.

In the embodiment of the present disclosure, step S204 in FIG. 2 may further include steps S304 and S305 as follows:

S304, determining first difference code between the optimized code and the target pasted code.

By example, the optimized code and the target pasted code can be compared in a diff method (a technique used to compare differences between two files or code versions) to determine the first difference code between the optimized code and the target pasted code.

S305, outputting the first difference code.

By example, after the first difference code between the optimized code and the target pasted code is determined, the first difference code can be output. In an implementation, the first difference code can be highlighted to make it easier for the developer to observe and understand code that differs. For example, second difference code included in the target pasted code and third difference code included in the optimized code may be highlighted, bolded or displayed in a specific color, etc., where the first difference code includes the second difference code and the third difference code, and a display mode of the difference code is not limited in the embodiment of the present disclosure.

S306, in response to an acceptance instruction for the optimized code being received, replacing the second difference code included in the target pasted code with the third difference code included in the optimized code, where the first difference code includes the second difference code and the third difference code.

In this step, after the developer has determined to adopt the optimized code corresponding to the target pasted code, for example, the acceptance instruction for the optimized code can be trigger by using a Tab key (a function key on a computer keyboard). Accordingly, the electronic device executing the method embodiment, in response to the acceptance instruction for the optimized code, replaces the second difference code included in the target pasted code with the third difference code included in the optimized code, where the first difference code includes the second difference code and the third difference code. It can be understood that the developer can adopt some or all of the difference code in the optimized code. It should be noted that the embodiment of the present disclosure does not limit a triggering mode of the acceptance instruction.

S307, marking the target pasted code and the optimized code as valid training data, where the valid training data is used to train the code optimization model.

In this step, after the second difference code included in the target pasted code is replaced by the third difference code included in the optimized code, it is indicated that the optimized code is high-quality code, and therefore, the target pasted code and the optimized code can be marked as valid training data to continue to be used to train the code optimization model. Through the above methods, the training data can be continuously accumulated and the effect of the code optimization model can be continuously optimized.

S308, in response to a cancellation instruction for the optimized code being received, or in response to determining that a stay time of the optimized code in the code development environment reaches a preset stay time, retaining the target pasted code.

In this step, after the developer determines not to adopt the optimized code corresponding to the target pasted code, for example, the cancellation instruction for the optimized code can be trigger by using an ESC key (a function key on a computer keyboard). Accordingly, in response to the cancellation instruction for the optimized code, the electronic device executing the method embodiment cancels display of the optimized code, and retains the target pasted code. It should be noted that the embodiment of the present disclosure does not limit a triggering mode of the cancellation instruction. Alternatively, after the stay time of the optimized code in the code development environment reaches the preset stay time (such as 500 ms), the developer does not perform any action, indicating that the developer does not adopt the optimized code corresponding to the target pasted code, and therefore, the electronic device executing the method embodiment will cancel the display of the optimized code and retain the target pasted code.

S309, marking the target pasted code and the optimized code as invalid training data.

In this step, in a case that the target pasted code is maintained, it means that the quality of the optimized code is not high. Therefore, the target pasted code and the optimized code can be marked as the invalid training data, and reasons for the low quality of the optimized code can be analyzed manually.

It should be noted that the embodiment of the present disclosure does not limit an execution sequence of S306 and S308.

In the embodiment of the present disclosure, by performing the dependency analysis for the relevant information of the acquired target pasted code, where the relevant information includes at least one of file information, class information or function information that the target pasted code depends on, the context-dependent data corresponding to the target pasted code is obtained, the overall code structure and logic can be deeply understood, and the code format, quality, context understanding and semantic adaptation, etc. can be comprehensively considered. The target pasted code and the context-dependent data are input into the code optimization model, and the code optimization is performed for the target pasted code based on the context-dependent data to obtain the optimized code; the first difference code between the optimized code and the target pasted code is determined, and the first difference code is output, realizing automatic code optimization for the target pasted code, which can improve the development efficiency greatly, ensure the optimized code to be consistent with the existing code in the current code development environment in style and logic, and integrate the optimized code into the current code development environment seamlessly, and can improve code quality, reduce potential problems caused by code mismatches, and improve the coding experience for the developer. In response to the acceptance instruction for the optimized code being received, the second difference code included in the target pasted code is replaced by the third difference code included in the optimized code, where the first difference code includes the second difference code and the third difference code, and the target pasted code and the optimized code are marked as the valid training data, which can continuously accumulate the training data and continuously optimize the effect of the code optimization model.

The method for processing code provided by the embodiment of the present disclosure not only applies to various programming languages and development environments, but also provides a smarter, smoother coding experience for development teams. Especially in AI-assisted programming, the embodiment of the present disclosure can be seamlessly integrated with code-generation AI to provide more intelligent coding assistance, and further promote the improvement of software development efficiency and quality.

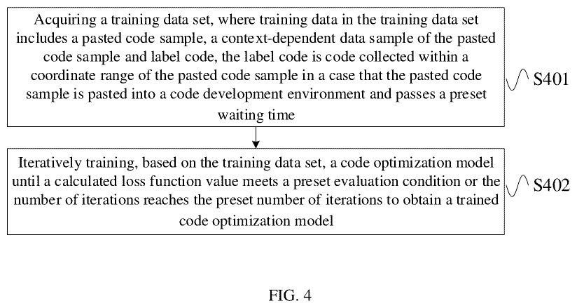

FIG. 4 is a schematic diagram according to a third embodiment of the present disclosure. As shown in FIG. 4, a method for training a code model provided by the third embodiment of the present disclosure can be applied to an electronic device, which may be a server or server cluster, etc. The method for training a code model provided by the third embodiment of the present disclosure includes:

S401, acquiring a training data set, where training data in the training data set includes a pasted code sample, a context-dependent data sample of the pasted code sample and label code, the label code is code collected within a coordinate range of the pasted code sample in a case that the pasted code sample is pasted into a code development environment and passes a preset waiting time.

In the embodiment of the present disclosure, the training data in the training data set is acquired based on data truly annotated by a developer in the code development environment, which can ensure the authenticity, diversity and high quality of the training data set from the data origin, and highly conform to the developer's programming habits. By example, in response to a sample code paste event of the developer being monitored in the integrated development environment, in a case that the pasted code sample is pasted into the integrated development environment and passes a preset waiting time (such as 15 seconds), code within the coordinate range of the pasted code sample is collected. The collected code is the actually-used code that has been confirmed by the developer, and can be used as the label code. Based on the collected code and the pasted code sample, the training data is obtained, which includes a pasted code sample, a context-dependent data sample of the pasted code sample and label code. For details on how to acquiring the training data, reference can be made to subsequent embodiments and the details will not be given here. In this step, a high-quality, diversified training data set can be got from real annotations made by the developer.

S402, iteratively training, based on the training data set, a code optimization model until a calculated loss function value meets a preset evaluation condition or the number of iterations reaches the preset number of iterations to obtain a trained code optimization model.

By example, the code optimization model can be fine-tuning trained based on a common large code model. The training data in the training data set is inputted into the code optimization model, and the code optimization model is iteratively trained. For example, the loss function value can be acquired based on predicted code outputted by the code optimization model and the label code, model parameters of the code optimization model can be adjusted according to the loss function value, and the trained code optimization model is obtained when the loss function value meets the preset evaluation condition. Alternatively, when the number of iterations reaches the preset number of iterations, the training can be stopped and the trained code optimization model can be obtained.

In an implementation, code optimization performed by the code optimization model includes at least one of the following: comment addition, comment modification, variable modification, function name modification, code format adjustment, configuration parameter adjustment, code symbol completion, or business logic change.

It can be understood that in order to ensure diversity of the training data, after comprehensive consideration of code format, quality, context understanding, semantic adaptation, etc., the code optimization categories can be divided into various categories like comment addition, comment modification, variable modification, function name modification, code format adjustment, configuration parameter adjustment, code symbol completion, business logic change, etc. to ensure a balanced proportion of training data for each category. For example, specific code optimization categories can include more than 20 categories to ensure that the optimized code is consistent with the existing code in the current code development environment in style and logic, and integrate the optimized code integrated into the current code development environment seamlessly.

In the embodiment of the present disclosure, the pasted code sample, the context-dependent data sample of the pasted code sample and the label code, included in the training data in the training data set, are acquired based on data truly annotated by the developer in the code development environment, which can ensure the authenticity, diversity and high quality of the training data set from the data origin, and highly conform to the developer's programming habits. The code optimization model is iteratively trained based on the high-quality training data set, which can ensure the output quality of the trained code optimization model. Thus, when the code optimization model is used to optimize the pasted code, it can be ensured that the optimized code is consistent with the existing code in the current code development environment in style and logic, and the optimized code can be seamlessly integrated into the current code development environment to improve code quality.

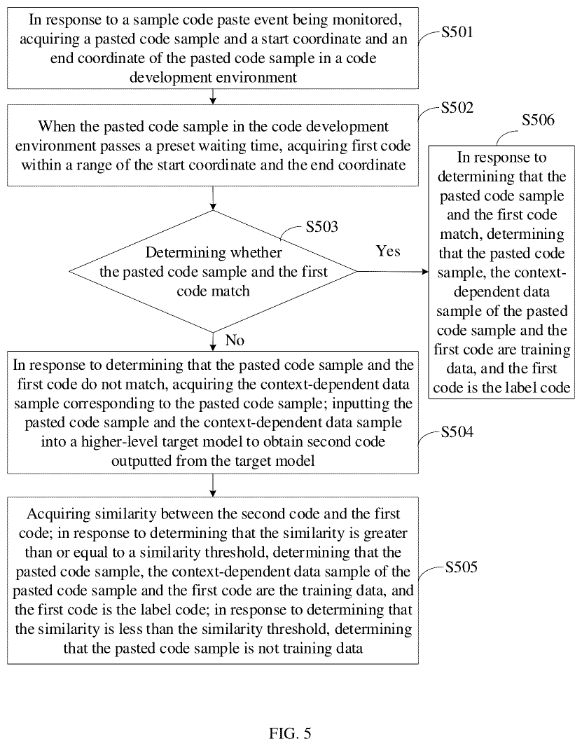

FIG. 5 is a schematic diagram of a fourth embodiment according to the present disclosure. As shown in FIG. 5, a method for acquiring a training data set provided by the fourth embodiment of the present disclosure includes:

S501, in response to a sample code paste event being monitored, acquiring a pasted code sample and a start coordinate and an end coordinate of the pasted code sample in a code development environment.

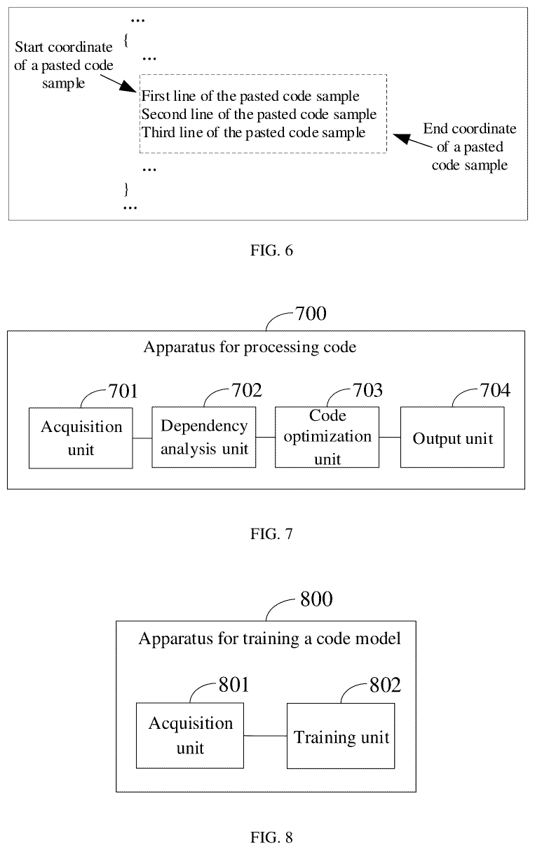

By example, in the process of software development, the developer pastes code from other places into the integrated development environment. Accordingly, the electronic device executing the method embodiment can monitor the sample code paste event, and thus acquire the pasted code sample and the start coordinate and the end coordinate of the pasted code sample in the integrated development environment. The pasted code sample can also be understood as an original code block to paste. FIG. 6 is a schematic diagram according to a fifth embodiment of the present disclosure. As shown in FIG. 6, the pasted code sample contains three lines of code, and FIG. 6 shows the start coordinate and end coordinate of the pasted code sample in the integrated development environment.

S502, when the pasted code sample in the code development environment passes a preset waiting time, acquiring first code within the range of the start coordinate and the end coordinate.

By example, the preset waiting time is, for example, 15 seconds, and the embodiment of the present disclosure does not limit the preset waiting time. After pasting the pasted code sample into the code development environment, wait for 15 seconds, and then obtain the first code within the range of the start coordinate and end coordinate. The first code is the really-used code which has been confirmed by the developer, and the first code can be used as the label code.

S503, determining whether the pasted code sample and the first code match.

In this step, the pasted code sample and the first code can be compared to determine whether the pasted code sample and the first code match, that is, whether the pasted code sample has changed. If the pasted code sample and the first code match exactly, the pasted code sample and the first code are marked as “not changed”; if the pasted code sample and the first code do not match exactly, the pasted code sample and the first code are marked as “changed”. In this way, data truly annotated by a developer can be acquired, including situations where change is needed and where change is not needed, so that the code optimization model can learn accurately when to make code optimization adjustments. If the pasted code sample does not match the first code, then perform steps S504 and S505; if the pasted code sample matches the first code, perform step S506.

S504, in response to determining that the pasted code sample and the first code do not match, acquiring the context-dependent data sample corresponding to the pasted code sample; inputting the pasted code sample and the context-dependent data sample into a higher-level target model to obtain second code outputted from the target model.

By example, after determining that the pasted code sample and the first code do not match, the pasted code sample and the first code are marked as “changed”, and dependency analysis is performed for the pasted code sample which is “changed”, such as analyzing which files, classes or functions (such as function signatures and function return values) the pasted code sample depends on, as the key data for the analysis of context, so as to obtain the context-dependent data sample of the pasted code sample. To further ensure the high quality of the training data, the pasted code sample and the context-dependent data sample can be assembled into a prompt, and inputted into the higher-level target model for changing, to obtain second code outputted from the target model.

S505, acquiring similarity between the second code and the first code; in response to determining that the similarity is greater than or equal to a similarity threshold, determining that the pasted code sample, the context-dependent data sample of the pasted code sample and the first code are the training data, and the first code is the label code; in response to determining that the similarity is less than the similarity threshold, determining that the pasted code sample is not training data.

For example, data levels can be classified according to different similarity thresholds. For example, data can be classified according to the order of similarity from high to low, and data can be divided into four levels: P0, P1, P2, and P3, where the similarity threshold corresponding to P0 level is 90%. In this step, the similarity between the second code and the first code can be obtained. If the similarity is greater than or equal to the similarity threshold of 90%, it is determined that the pasted code sample, the context-dependent data sample of the pasted code sample, and the first code are the training data and the first code is the label code, that is, the data of P0 level is preferentially selected as the valid training data. This step can be understood as performing data cleaning on training data to obtain high-quality training data.

S506, in response to determining that the pasted code sample and the first code match, determining that the pasted code sample, the context-dependent data sample of the pasted code sample and the first code are training data, and the first code is the label code.

In this step, after it is determined that the pasted code sample and the first code match exactly, and the pasted code sample and the first code are marked as “not changed”, the pasted code sample, the context-dependent data sample of the pasted code sample and the first code can be used as the training data, where the first code is the label code.

In the embodiment of the present disclosure, in response to a sample code paste event being monitored, a pasted code sample and a start coordinate and an end coordinate of the pasted code sample in the code development environment are acquired, and when the pasted code sample in the code development environment passes the preset waiting time, the first code within the range of the start coordinate and the end coordinate is acquired, whether the pasted code sample matches the first code is determined, the training data truly annotated by the developer in the code development environment can be acquired, and the authenticity of the training data can be ensured from the data origin. In response to determining that the pasted code sample does not match the first code, the context-dependent data sample corresponding to the pasted code sample is acquired, and the pasted code sample and the context-dependent data sample are input into a higher-level target model to obtain second code outputted from the target model, realizing cleaning of the training data based on the similarity between the second code and the first code, which can further improve the quality of training data, make the training data highly conform to the programming habits of the developer, and finally obtain a high-quality and diversified training data set from the real annotations of the developer for the training of the code optimization model, and ultimately ensure the high-quality output of the code optimization model.

Based on the above embodiment, it can be understood that the method for processing code provided by the present embodiment of the disclosure will provide a significant competitive advantage to the intelligent coding assistant and can greatly enhance the market value and leading position of the product. By analyzing the context of the pasted code in real time and automatically optimizing the pasted code, not only can development efficiency be greatly improved, but also code quality and consistency can be ensured, which can enable intelligent coding assistant to attract more the developer and enterprise users, thereby expanding market share and consolidating product leadership. Especially in the context of the increasing popularity of AI-assisted programming, the method for processing code provided by the embodiment of the present disclosure will become a key differentiating feature of the intelligent coding assistant, helping to attract and reserve high-value customers, and further consolidating the market position of the product in the field of AI-assisted programming.

In addition, the method for processing code provided by the embodiment of the present disclosure can build a strong technical barrier for the intelligent coding assistant and lay a solid foundation for future technological innovation and product iteration. The code optimization model trained with a large amount of real development data, combined with capabilities of real-time context analysis and code optimization for pasted code, can protect the core competitiveness of the product, and continue to improve the developer experience and enhance developer stickiness. Based on the method for processing code provided by the embodiment of the present disclosure, the intelligent coding assistant will establish clear advantages in code quality, development efficiency, developer experience, etc., thereby maintaining a long-term leading position in the fierce market competition.

The following are apparatus embodiments of the present disclosure which may be used to perform the method embodiments of the present disclosure. For details not disclosed in the apparatus embodiments of the present disclosure, please refer to the method embodiments of the present disclosure.

FIG. 7 is a schematic diagram according to a sixth embodiment of the present disclosure. As shown in FIG. 7, an apparatus 700 for processing code provided by the sixth embodiment of the present disclosure includes: an acquisition unit 701, a dependency analysis unit 702, a code optimization unit 703, and an output unit 704, where:
the acquisition unit 701 is configured to acquire target pasted code in response to a code paste event being monitored;
the dependency analysis unit 702 is configured to perform dependency analysis for the target pasted code to obtain context-dependent data corresponding to the target pasted code;
the code optimization unit 703 is configured to perform, according to the context-dependent data, code optimization for the target pasted code to obtain optimized code corresponding to the target pasted code; and
the output unit 704 is configured to output the optimized code.

In some embodiments, the code optimization unit 703 includes: a code optimization module (not shown in the figures), configured to input the target pasted code and the context-dependent data into the code optimization model to perform code optimization for the target pasted code based on the context-dependent data to obtain the optimized code; where the code optimization model is acquired based on training with a pasted code sample in the code development environment, a context-dependent data sample of the pasted code sample and label code, where the label code is code collected within a coordinate range of the pasted code sample in a case that the pasted code sample is pasted into a code development environment and passes a preset waiting time.

In some embodiments, the code optimization module is also configured to: empty the output of the code optimization model in a case that the target pasted code is determined not to be optimized.

In some embodiments, the code optimization includes at least one of the following: comment addition, comment modification, variable modification, function name modification, code format adjustment, configuration parameter adjustment, code symbol completion, or business logic change.

In some embodiments, the dependency analysis unit 702 includes: a dependency analysis module (not shown in the figures), configured to: perform the dependency analysis for relevant information of the target pasted code to obtain the context-dependent data corresponding to the target pasted code, where the relevant information includes at least one of file information, class information or function information that the target pasted code depends on.

In some embodiments, the apparatus 700 for processing the code also includes a first processing unit (not shown in the figures), configured to determine first difference code between the optimized code and the target pasted code; and output the first difference code.

In some embodiments, the apparatus 700 for processing the code also includes a second processing unit (not shown in the figures), configured to in response to an acceptance instruction for the optimized code being received, replace second difference code included in the target pasted code with third difference code included in the optimized code, where the first difference code includes the second difference code and the third difference code; and mark the target pasted code and the optimized code as valid training data, where the valid training data is used to train the code optimization model.

In some embodiments, the apparatus 700 for processing the code also includes a third processing unit (not shown in the figures), configured to in response to a cancellation instruction for the optimized code being received, or in response to determining that a stay time of the optimized code in the code development environment reaches a preset stay time, retain the target pasted code; and mark the target pasted code and the optimized code as invalid training data.

The apparatus for processing code provided in FIG. 7 can execute the steps in the method embodiment corresponding to the above method for processing code, and its implementation principle and technical effect are similar, which will not be repeated here.

FIG. 8 is a schematic diagram according to a seventh embodiment of the present disclosure. As shown in FIG. 8, an apparatus 800 for training a code model provided by the seventh embodiment of the present disclosure includes: an acquisition unit 801 and a training unit 802, where:
the acquisition unit 801 is configured to acquire a training data set, where training data in the training data set includes a pasted code sample, a context-dependent data sample of the pasted code sample and label code, and the label code is code collected within a coordinate range of the pasted code sample in a case that the pasted code sample is pasted into a code development environment and passes a preset waiting time;
the training unit 802 is configured to iteratively train, based on the training data set, a code optimization model until a calculated loss function value meets a preset evaluation condition or the number of iterations reaches the preset number of iterations to obtain a trained code optimization model.

In some embodiments, the acquisition unit 801 includes: a first acquisition module (not shown in the figures), configured to in response to a sample code paste event being monitored, acquire the pasted code sample and a start coordinate and an end coordinate of the pasted code sample in the code development environment; a second acquisition module (not shown in the figures), configured to, in a case that the pasted code sample in the code development environment passes the preset waiting time, acquire first code within the range of the start coordinate and the end coordinate; a first processing module (not shown in the figures), configured to in response to determining that the pasted code sample does not match the first code, acquire the context-dependent data sample corresponding to the pasted code sample; input the pasted code sample and the context-dependent data sample into a higher-level target model to obtain second code outputted from the target model; acquire similarity between the second code and the first code; in response to determining that the similarity is greater than or equal to a similarity threshold, determine that the pasted code sample, the context-dependent data sample of the pasted code sample and the first code are the training data, and the first code is the label code; in response to determining that the similarity is less than the similarity threshold, determine that the pasted code sample is not training data; a second processing module (not shown in the figures), configured to in response to determining that the pasted code sample matches the first code, determine that the pasted code sample, the context-dependent data sample of the pasted code sample and the first code are training data, and the first code is the label code.

In some embodiments, the code optimization includes at least one of the following: comment addition, comment modification, variable modification, function name modification, code format adjustment, configuration parameter adjustment, code symbol completion, or business logic change.

The apparatus for training the code model provided in FIG. 8 can executes the steps in the method embodiment corresponding to the above method for training the code model, and its implementation principle and technical effect are similar, which will not be repeated here.

According to an embodiment of the present disclosure, an electronic device is also provided by the present disclosure, the electronic device includes: at least one processor; and a memory in communicative connection with the at least one processor; where the memory stores instructions that can be executed by the at least one processor, and the instructions are executed by the at least one processor to enable the at least one processor to execute the solution provided by any of the above embodiments.

According to an embodiment of the present disclosure, a non-transitory computer-readable storage medium storing computer instructions is also provided by the present disclosure, where the computer instructions are used to cause a computer to execute the solution provided by any of the above embodiments.

According to an embodiment of the disclosure, a computer program product is also provided by the present disclosure, the computer program product includes: a computer program, the computer program is stored in a readable storage medium, at least one processor of an electronic device can read the computer program from the readable storage medium, and the at least one processor executes the computer program to cause the electronic device to execute the solution provided by any of the above embodiments.

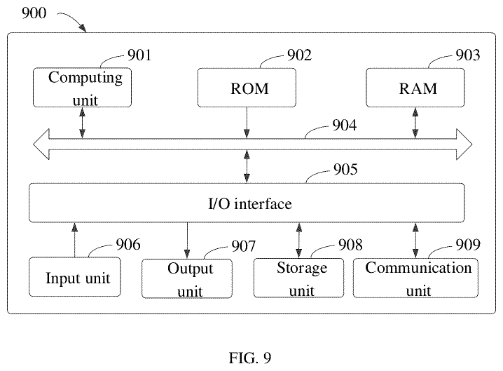

FIG. 9 is a schematic block diagram of an example electronic device 900 that may be used to implement an embodiment of the present disclosure. The electronic device is intended to represent various forms of digital computers, such as laptops, desktop computers, workstations, personal digital assistants, servers, blade servers, mainframes, and other suitable computers. The electronic device can also represent various forms of mobile apparatus, such as personal digital assistants, cellular phones, smart phones, wearable devices, and other similar computing apparatus. The components, their connections and relationships, and their functionality shown herein are only examples and are not intended to limit the implementations of the present disclosure described herein and/or required herein.

As shown in FIG. 9, the electronic device 900 includes a computing unit 901, which can perform various appropriate actions and processes according to a computer program stored in a read only memory (ROM) (taking ROM 902 as an example in FIG. 9) or a computer program loaded from a storage unit 908 into a random access memory (RAM) (taking RAM 903 as an example in FIG. 9). In RAM 903, various programs and data required for the operation of the electronic device 900 can also be stored. The computing unit 901, ROM 902, and RAM 903 are connected to each other via a bus 904. The input/output (I/O) interface (taking I/O interface 905 as an example in FIG. 9) is also connected to the bus 904.

A number of components in the electronic device 900 are connected to the I/O interface 905, including: an input unit 906, such as a keyboard, mouse, etc.; an output unit 907, such as various types of displays, speakers, etc.; a storage unit 908, such as a disk, a CD, etc.; and a communication unit 909, such as a network card, a modem, a wireless communication transceiver, etc. The communication unit 909 allows the electronic device 900 to exchange information/data with other devices over a computer network such as the Internet and/or various telecommunications networks.

The computing unit 901 may be a variety of general-purpose and/or special-purpose processing components with processing and computing capabilities. Some examples of the computing unit 901 include, but are not limited to, a central processing unit (CPU), a graphic processing unit (GPU), various special-purpose artificial intelligence (AI) computing chips, various computing units running machine learning model algorithms, a digital signal processor (DSP), and any appropriate processors, controllers, microcontrollers, etc. The computing unit 901 executes the various methods and processes described above, such as methods for processing code. For example, in some embodiments, the method for processing code may be implemented as a computer software program that is tangibly contained in a machine-readable medium, such as the storage unit 908. In some embodiments, part or all of the computer program may be loaded and/or installed on the electronic device 900 via ROM 902 and/or communication unit 909. When a computer program is loaded into RAM 903 and executed by the computing unit 901, one or more steps of the method for processing code described above can be executed. Alternatively, in other embodiments, the computing unit 901 may be configured to execute the method for processing code by any other appropriate means (e.g., by means of firmware).

The various implementations of the systems and technologies described above herein can be implemented in a digital electronic circuit system, an integrated circuit system, a field program gate array (FPGA), an application specific integrated circuit (ASIC), application specific standard parts (ASSP), a system on a chip (SOC), a complex programming logic device (CPLD), computer hardware, firmware, software, and/or a combination of them. These various implementations may include: implementation in one or more computer programs that may be executed and/or interpreted on a programmable system including at least one programmable processor. The programmable processor may be a specialized or general-purpose programmable processor, that may receive data and instructions from a storage system, at least one input apparatus, and at least one output apparatus, and transmit data and instructions to the storage system, the at least one input apparatus, and the at least one output apparatus.

Program code for implementing the methods of the present disclosure may be written in any combination of one or more programming languages. These program codes may be provided to a processor or controller of a general-purpose computer, a special-purpose computer or other programmable data processing apparatus so that when the program code is executed by the processor or controller, the functions/operations specified in the flow diagram and/or block diagram are implemented. The program code can be executed entirely on a machine, partially on a machine, be executed partially on a machine and partially on a remote machine or completely on a remote machine or server as a stand-alone package.

In the context of the present disclosure, a machine readable medium may be a tangible medium that may contain or store programs for use by or in conjunction with an instruction executing system, apparatus or device. The machine readable medium may be a machine readable signal medium or a machine readable storage medium. The machine readable medium may include, but are not limited to, electronic, magnetic, optical, electromagnetic, infrared, or semiconductor systems, apparatus, or device, or any suitable combination of the above. More specific examples of a machine readable storage medium would include electrical connections based on one or more wires, portable computer disks, hard disks, random access memory (RAM), read-only memory (ROM), erasable programmable read only memory (EPROM or flash memory), optical fiber, compact disc read-only memory (CD-ROM), optical storage devices, magnetic storage devices, or any suitable combination of the above.

In order to provide interaction with a user, the systems and technologies described herein may be implemented on a computer having: a display apparatus (e.g., CRT (cathode ray tube) or LCD (liquid crystal display) monitor) for displaying information to the user; and a keyboard and a pointing apparatus (for example, a mouse or trackball) through which the user can provide input to the computer. Other types of apparatus may also be used to provide interaction with the user; for example, feedback provided to the user can be any form of sensory feedback (for example, visual feedback, auditory feedback, or haptic feedback); input from the user can be received in any form (including acoustic input, voice input, or haptic input).

The systems and technologies described herein may be implemented in a computing system that includes back-end components (for example, as a data server), or a computing system that includes middleware components (for example, an application server), or a computing system that includes front-end components (for example, a user computer with a graphical user interface or a web browser, the user may interact with implementations of the system and technology described herein through the graphical user interface or the web browser), or in a computing system that includes any combination of such back-end components, middleware components, or front-end components. The components of the system can be connected to each other through digital data communication in any form or medium (for example, communication networks). Examples of the communication networks include: a local area network (LAN), a wide area network (WAN), and the Internet.

A computer system can include both a client and a server. The client and the server are generally far away from each other and usually interact over a communication network. A client-server relationship is generated by computer programs that run on the corresponding computers and have a client-server relationship with each other. The server can be a cloud server, also known as cloud computing server or cloud host, which is a host product in a cloud computing service system to solve defects of traditional physical host and VPS service (“Virtual Private Server”, or “VPS” for short), which are high management difficulty and weak business scalability. The server can also be a server of a distributed system, or a server that combines a blockchain.

It should be understood that steps can be reordered, added, or removed using various forms of processes shown above. For example, the steps described in the present disclosure may be performed in parallel, sequentially, or in different orders, so long as the results desired by the technical solution disclosed in the present disclosure are achieved, and there are no limitations herein.

The above specific implementations shall not constitute a limitation of the scope of protection of the present disclosure. It should be understood by those skilled in the art that various modifications, fusions, sub-fusions, and substitutions may be made depending on design requirements and other factors. Any modification, equivalent replacement, improvement, etc. made within the spirit and principles of the present disclosure shall be included in the scope of protection of the present disclosure.

What is claimed is:

1. A method for processing code, comprising:
acquiring target pasted code in response to a code paste event being monitored;
performing dependency analysis for the target pasted code to obtain context-dependent data corresponding to the target pasted code;
performing, according to the context-dependent data, code optimization for the target pasted code to obtain optimized code corresponding to the target pasted code; and
outputting the optimized code.

2. The method according to claim 1, wherein the performing, according to the context-dependent data, code optimization for the target pasted code to obtain the optimized code corresponding to the target pasted code comprises:
by inputting the target pasted code and the context-dependent data into a code optimization model, performing code optimization for the target pasted code based on the context-dependent data to obtain the optimized code;
wherein the code optimization model is acquired based on training with a pasted code sample in a code development environment, a context-dependent data sample of the pasted code sample and label code, the label code is code collected within a coordinate range of the pasted code sample in a case that the pasted code sample is pasted into the code development environment and passes a preset waiting time.

3. The method according to claim 2, wherein the method further comprises:
an output of the code optimization model is empty in a case that the target pasted code is determined not to be optimized.

4. The method according to claim 2, wherein the code optimization comprises at least one of the following:
comment addition, comment modification, variable modification, function name modification, code format adjustment, configuration parameter adjustment, code symbol completion, or business logic change.

5. The method according to claim 1, wherein the performing dependency analysis for the target pasted code to obtain the context-dependent data corresponding to the target pasted code comprises:
performing the dependency analysis for relevant information of the target pasted code to obtain the context-dependent data corresponding to the target pasted code, wherein the relevant information comprises at least one of file information, class information or function information that the target pasted code depends on.

6. The method according to claim 2, wherein the method further comprises:
determining first difference code between the optimized code and the target pasted code; and
outputting the first difference code.

7. The method according to claim 6, wherein the method further comprises:
in response to an acceptance instruction for the optimized code being received, replacing second difference code comprised in the target pasted code with third difference code comprised in the optimized code, wherein the first difference code comprises the second difference code and the third difference code; and
marking the target pasted code and the optimized code as valid training data, wherein the valid training data is used for training the code optimization model.

8. The method according to claim 7, wherein the method further comprises:
in response to a cancellation instruction for the optimized code being received, or in response to determining that a stay time of the optimized code in the code development environment reaches a preset stay time, retaining the target pasted code; and
marking the target pasted code and the optimized code as invalid training data.

9. A method for training a code model, comprising:
acquiring a training data set, wherein training data in the training data set comprises a pasted code sample, a context-dependent data sample of the pasted code sample and label code, the label code is code collected within a coordinate range of the pasted code sample in a case that the pasted code sample is pasted into a code development environment and passes a preset waiting time;
iteratively training, based on the training data set, a code optimization model until a calculated loss function value meets a preset evaluation condition or a number of iterations reaches a preset number of iterations, to obtain a trained code optimization model.

10. The method according to claim 9, wherein the acquiring the training data set comprises:
in response to a sample code paste event being monitored, acquiring the pasted code sample and a start coordinate and an end coordinate of the pasted code sample in the code development environment;
when the pasted code sample in the code development environment passes the preset waiting time, acquiring first code within a range of the start coordinate and the end coordinate;
in response to determining that the pasted code sample does not match the first code, acquiring the context-dependent data sample corresponding to the pasted code sample; inputting the pasted code sample and the context-dependent data sample into a higher-level target model to obtain second code outputted from the target model; acquiring similarity between the second code and the first code; in response to determining that the similarity is greater than or equal to a similarity threshold, determining that the pasted code sample, the context-dependent data sample of the pasted code sample and the first code are the training data, and the first code is the label code;
in response to determining that the pasted code sample matches the first code, determining that the pasted code sample, the context-dependent data sample of the pasted code sample and the first code are the training data, and the first code is the label code.

11. The method according to claim 9, wherein the code optimization comprises at least one of the following:
comment addition, comment modification, variable modification, function name modification, code format adjustment, configuration parameter adjustment, code symbol completion, or business logic change.

12. An apparatus for processing code, comprising:
at least one processor; and
a memory communicating with the at least one processor; wherein
the memory stores instructions that can be executed by the at least one processor, and the instructions are executed by the at least one processor to enable the at least one processor to:
acquire target pasted code in response to a code paste event being monitored;
perform dependency analysis for the target pasted code to obtain context-dependent data corresponding to the target pasted code;
perform, according to the context-dependent data, code optimization for the target pasted code to obtain optimized code corresponding to the target pasted code; and
output the optimized code.

13. The apparatus according to claim 12, wherein the instructions are executed by the at least one processor to enable the at least one processor further to:
input the target pasted code and the context-dependent data into a code optimization model, perform code optimization for the target pasted code based on the context-dependent data to obtain the optimized code;
wherein the code optimization model is acquired based on training with a pasted code sample in a code development environment, a context-dependent data sample of the pasted code sample and label code, wherein the label code is code collected within a coordinate range of the pasted code sample in a case that the pasted code sample is pasted into the code development environment and passes a preset waiting time.

14. The apparatus according to claim 13, wherein the instructions are executed by the at least one processor to enable the at least one processor further to:
empty the output of the code optimization model in a case that the target pasted code is determined not to be optimized.

15. The apparatus according to claim 13, wherein the code optimization comprises at least one of the following:
comment addition, comment modification, variable modification, function name modification, code format adjustment, configuration parameter adjustment, code symbol completion, or business logic change.

16. The apparatus according to claim 12, wherein the instructions are executed by the at least one processor to enable the at least one processor further to:
perform the dependency analysis for relevant information of the target pasted code to obtain the context-dependent data corresponding to the target pasted code, wherein the relevant information comprises at least one of file information, class information or function information that the target pasted code depends on.

17. The apparatus according to claim 13, wherein the instructions are executed by the at least one processor to enable the at least one processor further to determine first difference code between the optimized code and the target pasted code; and output the first difference code.

18. The apparatus according to claim 17, wherein the instructions are executed by the at least one processor to enable the at least one processor further to in response to an acceptance instruction for the optimized code being received, replace second difference code comprised in the target pasted code with third difference code comprised in the optimized code, wherein the first difference code comprises the second difference code and the third difference code; and mark the target pasted code and the optimized code as valid training data, wherein the valid training data is used for training the code optimization model;
in response to a cancellation instruction for the optimized code being received, or in response to determining that a stay time of the optimized code in the code development environment reaches a preset stay time, retain the target pasted code; and mark the target pasted code and the optimized code as invalid training data.

19. An apparatus for training a code model, comprising:
at least one processor; and
a memory communicating with the at least one processor; wherein
the memory stores instructions that can be executed by the at least one processor, and the instructions are executed by the at least one processor to enable the at least one processor to the method according to claim 9.

20. A non-transitory computer-readable storage medium storing computer instructions, wherein the computer instructions are used to cause a computer to execute the method according to claim 1.
